(19) United States
(12) Patent Application Publication
(10) Pub. No.: US 2008/0130398 A1
(43) Pub. Date: Jun. 5, 2008

(54) Base and disposable bowl and method

(76) Inventor: Cathy Ponsford, Orange, CA (US)

Correspondence Address: Law Office of Terry L. Miller, 24832 Via San Fernando, Mission Viejo, CA, 92692, US

(21) Appl. No.: 11/633,293

(22) Filed: Dec. 4, 2006

(51) Int. Cl. B01F 11/00

(52) U.S. Cl. 366/111

(57) ABSTRACT

A combination of a durable base and a disposable bowl for mixing of ingredients by a cosmetician. The base provides for the base and bowl to be free-standing so that the cosmetician can conveniently mix ingredients for hair coloring preparation, for example, and can also access the mixed hair coloring preparation using only one hand, and without having to hold the bowl or base in position on a countertop. An integrally molded, radially, outwardly extending planar lip around the periphery of the top of the disposable bowl provides rigidity to the bowl, while cooperating features such as a radially extending key and divot respectively defined by the base and bowl insure that the bowl is non-rotational relative to the base. The bowl may be a light push-fit or snap-fit into the base to further maintain the desired secure attachment of the bowl to the base during use. On the other hand, a notch or recess in the base provides for convenient removal of the bowl from the base for disposal.

### BACKGROUND OF THE INVENTION

1. Field of the Invention

This invention relates generally to facilities for mixing ingredients used by a cosmetician for coloring of a client's hair. More particularly, this invention relates to a durable base or holder for resting on a countertop and having an opening or recess for snugly receiving and holding a disposable bowl. The disposable bowl is non-rotationally retained by the base so that hair coloring ingredients may be conveniently mixed in and dispensed from the disposable bowl.

2. Description of Related Art

Hair coloring procedures performed by a cosmetician often require ingredients to be mixed preparatory to the application of the hair coloring solution or preparation to the client's hair. Traditionally, cosmeticians mix hair coloring ingredients in a reusable mixing bowl with a reusable spatula or other implement. Reusable bowls, however, may harbor many disease producing microbes, which without proper precautions can transfer from one client to another. This is particularly the case with a plastic mixing bowl, the inner surface of which becomes scratched and scarred with continued use. The scratches and scars on the inner surface of the mixing bowl provide places in which microbes may be hidden to be passed to a successive client. In part for this reason, some of the companies which supply hair coloring preparations to cosmeticians also make appropriately sized plastic mixing bowls available to cosmeticians at low cost or for free. But, these mixing bowls are not supplied in sufficient quantity or at a sufficiently low cost that the bowls may be used only once and then discarded. Thus, the plastic mixing bowls in common use by cosmeticians receive many uses before they are discarded, and present the risk of microbes being passed from one client to successive clients.

In order to reduce the risk of cross contamination by such microbes when a durable mixing bowl is reused, it is necessary to carefully clean the bowl by a complex and time-consuming procedure. That is, each bowl is washed in warm, soapy water, rinsed and dried. Then the bowl may be sprayed with a disinfectant and allowed to air dry for several minutes. When the reusable mixing bowl is to be used again, it should be rinsed again under running water to remove any residual disinfectant. As will be apparent, the requirements for personnel time makes this an inefficient and expensive process. Also, as was mentioned above, once the inner surface of a plastic mixing bowl becomes scratched or scarred, then effectively cleaning of this mixing bowl becomes essentially impossible.

Another consideration is that the conventional plastic mixing bowls in use by cosmeticians are small, light, and have a relatively small base. This makes the conventional bowls likely to tip and spill the contents of the bowl, especially if the cosmetician attempts to either mix ingredients in the bowl without holding it in one hand while mixing with the other, or if the cosmetician attempts to dispense the mixed preparation from the bowl while the bowl rests on a countertop. Thus, the conventional plastic mixing bowls are inconvenient in that they often require both hands to be used, at a time when the cosmetician would like to have a hand free.

U.S. Pat. No. 6,672,248 is believed to disclose a disposable bowl to be employed in the preparation of ready-to-eat pet food. However, this bowl appears to have no utility for mixing and dispensing hair coloring preparations.

Similarly, U.S. Pat. No. 6,116,772 appears to disclose a disposable bowl and spatula for use in a dental office. This disposable bowl is free standing and would appear to require a user of the bowl to hold the bowl in one hand while the other hand is used with the spatula to mix ingredients in the bowl. A mixing bowl supported on a base allowing one hand to be used for mixing of ingredients in the bowl, and after mixing is complete, to allow one hand to be used for dispensing the preparation from the bowl, is desired.

On the other hand, U.S. design Pat. DES 342,350 appears to be adapted to hold a pair of pet feeding bowls, but the bowls are not held non-rotationally in the holder, so this holder would not conveniently allow mixing of ingredients in the bowls. Also, this pet feeding bowl holder includes handle portions which would interfere with use of the holder with a bowl in which ingredients were to be mixed and dispensed after mixing.

None of the prior art discloses or suggests a durable base receiving and non-rotationally holding a disposable bowl for the mixing of hair coloring preparations, and from which the mixed preparation is conveniently dispensed after mixing. There remains a need for a base with a disposable bowl adapted for mixing hair coloring preparations and for optimizing the mixing process, and from which the mixed preparation can be conveniently dispensed after mixing is complete.

### SUMMARY OF THE INVENTION

Therefore it is an object of this invention to provide a base having a recess or opening for snugly and non-rotationally receiving a disposable bowl for mixing a hair coloring preparation.

An object of this invention is to configure the base and bowl for optimized mixing of ingredients in the bowl using one hand, and after mixing is complete to allow dispensing of the mixed preparation from the bowl also using only one hand.

Another object of this invention is to provide such a disposable bowl for use in the combination described above, and which is of sufficiently low-cost and low in material-use, that it may economically be disposed of after a single use.

Still another object of this invention is to provide a disposable bowl with sufficient rigidity to allow mixing of ingredients in the bowl while the bowl is supported in a durable base.

Accordingly, an object of this invention is to provide a disposable mixing bowl for mixing of hair color preparations, that is disposable so that cleanup operations are eliminated.

Finally, an object of this invention is to provide a disposable mixing bowl for mixing of hair color preparations, that is disposable so that the possibility of passing microbes from one client to successive clients is completely eliminated.

In accordance with one aspect of this invention a base and disposable bowl for mixing hair coloring ingredients or preparations comprises in combination, a durable base and disposable bowl for allowing ingredients to be mixed in and dispensed from the bowl while the combination rests upon a support surface such as a countertop. This combination comprises: a durable base member including a body defining an opening for receiving and substantially non-rotationally holding a disposable bowl member, and the base member further including facility for frictionally engaging the body upon a support surface. A disposable bowl member of the combination is formed of fine-dimension plastic material, and including a basin portion for being received into the opening and for receiving ingredients to be mixed in the disposable bowl portion, the disposable bowl member further including a radially outwardly extending flange portion circumscribing the basin portion and for being disposed adjacent to the body portion about the opening when the basin portion of the bowl member is placed into the opening. And the body portion and the disposable bowl member define cooperating means for substantially non-rotationally retaining the bowl member removably within the opening of the base member.

In accordance with another object of this invention a method of mixing ingredients or preparations for hair coloring includes steps of providing a durable base member including a body portion defining an opening for receiving and substantially non-rotationally holding a disposable bowl member. Provided on the base member is a facility for frictionally engaging the body upon a support surface. Also provided is a disposable bowl member configured to be received into the opening of the durable base member and including a basin portion for receipt into the opening of the durable base member and for receiving ingredients to be mixed in the disposable bowl portion. The body portion of the base and the disposable bowl member are configured to define cooperating features for substantially non-rotationally retaining the bowl member removably within the opening of the base member, while the base member is frictionally supported upon the support surface so that ingredients may be mixed in the basin portion by a user utilizing only one hand without the base portion moving about on the support surface and without the bowl portion rotating relative to or removing from the base portion.

Additional objects and advantages of the present invention will appear from a reading of the following detailed description of a particularly preferred exemplary embodiment of the invention, taken in conjunction with the appended drawing Figures, in which like reference numerals refer to like parts, and in which:

### BRIEF DESCRIPTION OF THE DRAWING FIGURES

FIG. 1 provides a perspective view of a base and disposable bowl embodying the present invention;

FIG. 2 provides a perspective view of the base portion seen in FIG. 1;

FIG. 3 is an end elevation view of the base and disposable bowl seen in FIGS. 1 and 2;

FIG. 4 is an elevation view of a disposable bowl as seen in FIGS. 1-3;

FIG. 5 is an underside or bottom plan view of a disposable bowl as seen in FIGS. 1-4; and

FIG. 6 is an illustration of an alternative embodiment of the invention, shown in fragmentary cross sectional view at an enlarged size.

### DETAILED DESCRIPTION OF EXEMPLARY PREFERRED EMBODIMENTS

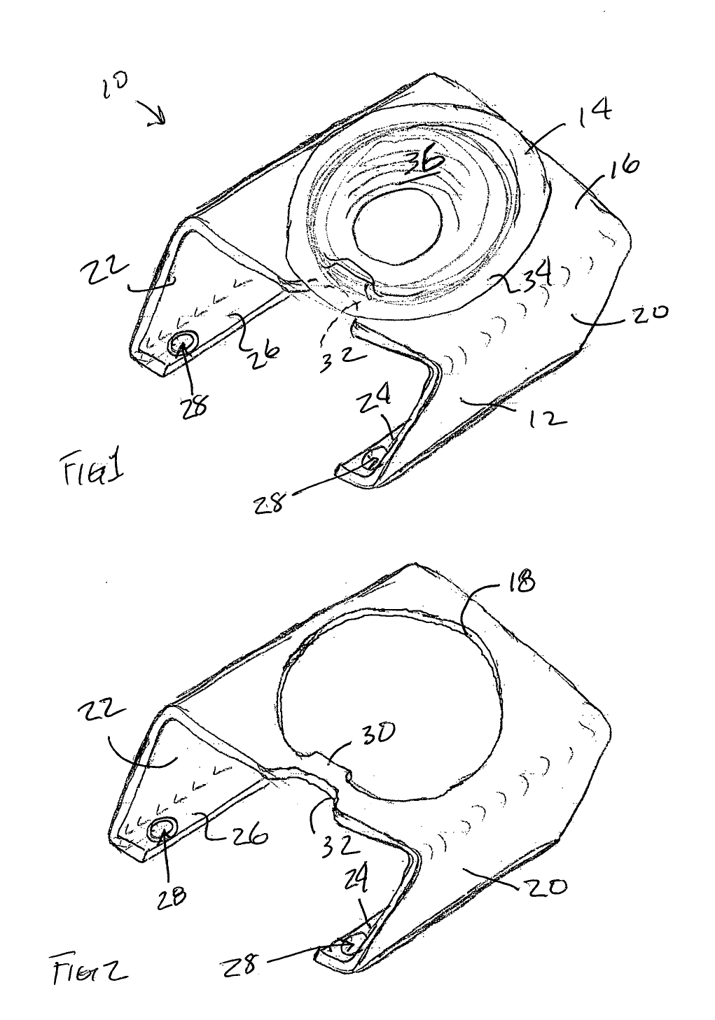

Considering FIGS. 1-5 in conjunction with one another, and noting that like reference numerals indicate the same or analogous features throughout the various drawing Figures, it is seen considering first FIG. 1, that a base and bowl combination 10 includes a base 12, receiving and non-rotationally supporting a bowl 14. Base 12 is generally of U-shape (albeit an inverted U-shape) and includes a top plate portion 16 defining a generally circular opening 18 (as is best seen in FIG. 2). The top plate portion 16 is integral with and is supported by a pair of flange-like depending leg portions 20 and 22. Each leg portion 20 and 22 terminates in an inwardly extending foot portion 24, 26. These foot portions 24, 26 each carry a pair of friction pad members (each indicated with the numeral 28) extending below the foot portions 24, 26, so that the base 12 by reason of its own weight has a high degree of frictional engagement with and is relatively frictionally immovable when placed on a counter top, for example. That is, when placed upon a counter top, the base 12 has a frictional engagement via the friction pads 28 with the counter top that will allow ingredients to be dispensed into and mixed in the bowl portion 14 without the base and bowl moving about or slipping away from a user.

In order to facilitate the base 12 being sufficiently heavy that it will frictionally engage upon the surface of a counter top via the friction pads 28, it is desirable that the base 12 be fabricated of a somewhat heavy and sturdy material. For this reason, as well as for aesthetic reasons, it is preferred that the base 12 be made of 14 or 16 gauge stainless steel, although the invention is not so limited. Alternatively, the base 12 may be made of formed plastic sheet material, such as Lexan® or acrylic sheet material, or may be injection molded, if desired. Added weight may be added to or incorporated into the base 12 to assist it in being heavy enough to facilitate frictional engagement with a countertop. In each case, it is to be noted that the base 12 has at top plate 16 a certain thickness or vertical extent, providing for the bowl 14 to engage within opening 18 with the base 12. It is further to be noted that the preferred embodiment of base 12 defines a pair of exposed side surface (i.e., the sides of depending legs 20, 22) which may conveniently carry product advertisements. This is a particular feature of the present invention which may make it attractive for adoption by one or more of the companies making hair coloring products in order to advertise their products to consumers. Thus, the base 12 and its disposable bowls 14 may be supplied to cosmeticians for free or at a very inexpensive price by one or more of these hair coloring companies, much like the deficient conventional plastic mixing bowls are presently so supplied.

Further considering FIG. 2, it is seen that the opening 18 is mostly (but not fully) circular. That is, the opening 18 is not fully circular because this preferred embodiment includes a circumferentially and radially inwardly extending key portion 30, which is integral with the top plate portion 16 of the base 12. Generally aligning with the key portion 30, the top plate portion 16 preferably defines a notch or recess 32 extending radially toward the opening 18, and which if partially overlapped by a radially outwardly extending flange portion 34 of the bowl 14. That is, the bowl 14 includes a basin portion 36 extending downwardly through the opening 18, and which may receive and hold contents for the bowl 14, and the radially outwardly extending flange portion 34 which rests upon the top plate portion 16.

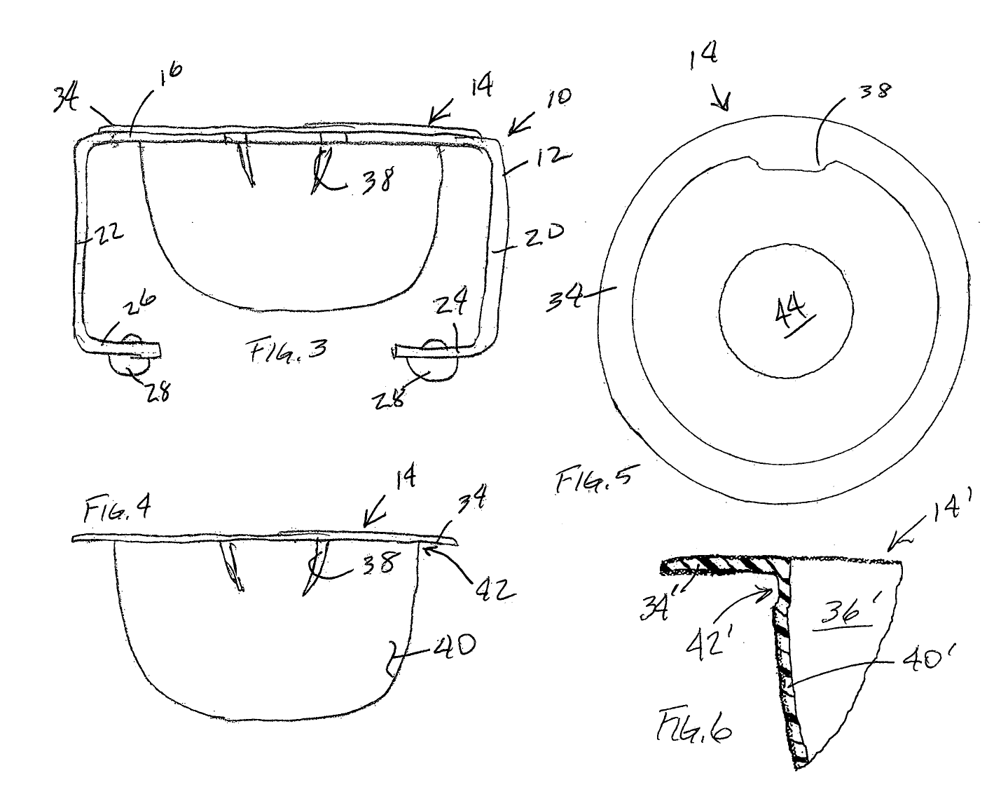

Considering FIGS. 3-5 especially and in conjunction with one another, it is seen that the disposable bowl 14 is most preferably formed of thin or fine-dimension plastic sheet stock, which may be blow-molded or vacuum formed (for example) into the shape seen in these drawing Figures, although the invention is not so limited. The disposable bowl 14 includes a basin portion 36 terminating in a radially outwardly extending flange portion 34, as was described immediately above. However, in order to insure that the bowl 14 is non-rotationally supported by the base 12, the bowl 14 also includes a radially inwardly extending shallow recess or divot 38, into which the key portion 30 is received when the bowl 14 is received into opening 18 of base 12. The bowl 14 may include additional or different features which assist in retaining the bowl 14 in opening 18, as will be further described below. That is, viewing particularly FIG. 4, the outer wall portion 40 of the basin part of bowl 14 may include an essentially cylindrical portion or band (indicated on FIG. 4 by the arrowed numeral 42) which is disposed immediately below the flange portion 34. In order to assist in retaining bowl 14 in opening 18, the portion 42 may define an outer diameter which is just slightly larger than the inner diameter of opening 18 defined by top plate 16 of the base 14. In this way, a light push-fit of the bowl 14 into opening 18 is established. That is, a user of the base 12 and bowl 14 would, when placing a new disposable bowl into the opening 18 need to push the bowl 14 into the opening 18, seating the flange portion 34 on the top plate 16, and seating the band 42 within the opening 18 of top plate portion 16. This light push-fit of the bowl 14 into opening 18 will assist in retaining the bowl 14 in opening 18, but will not prevent the used bowl from being removed from the base 12 by grasping and lifting the portion of flange 34 exposed at notch 32.

On the other hand, FIG. 6 illustrates an alternative construction for the disposable bowl. In FIG. 6, features which are now familiar are illustrated using the same reference numeral used above, and having a prime (′) added. Viewing FIG. 6, it is seen that an alternative construction may be effected for the wall portion 40′, such that a circumferential band of slightly reduced diameter is defined at 42′, and such that when a larger diameter lower portion of the bowl 14′ (i.e., immediately below the band 42′) when pressed through the opening 18, this action results in the bowl 14′ “snapping” into place into opening the opening 18. When the bowl 14′ is snapped into place in the base 12, the flange 34′ is adjacent to the top plate 16 of the base 12.

With either a light push-fit or snap-fit of the bowl into the opening 18, the bowl 14 (or 14′) will be securely retained within the top plate 16 of the base 12. Thus, it may be desired to make the opening 18 (and basin portion of bowl 14) purely circular in plan view, and dispense with the use of key 30 and divot 38. But, regardless of whether a key and divot, a push-fit, or a snap-fit of the disposable bowl 14 into base 12 is utilized, the bowl 14 is secure in the base such that a cosmetician may mix ingredients in the bowl and dispense mixed ingredients from this bowl using only a single hand, if desired. Thus, the use of this inventive base and bowl combination affects a considerable improvement in convenience for the cosmetician. Further, the client enjoys an improved safety because the disposable bowl 14 is used only once and then is discarded. Thus, disease causing microbes cannot be passed from one client to the next as with a conventional re-usable mixing bowl.

Further to the above, viewing FIG. 5 particularly, it is seen that the bowl 14 (or 14′) defines a centrally located outer flat or floor 44, such that the bowl 14 (or a stack of nested bowls) will set upright on a countertop. This allows the bowl to be set on a countertop even if not supported in the base 12 without the bowl tipping over and spilling its contents.

In the use of the base 12 and bowl 14, it is common for a cosmetician to desire to dispense hair coloring preparation into the basin 36, and to there mix this preparation with a carrier liquid or solvent, such as water or other solvent. This mixing is conducted prior to the cosmetician dispensing the hair coloring preparation from the basin 36 onto the client's hair, usually using a small brush. In both instances, the cosmetician desires to effect the mixing and dispensing with one hand, if possible, so that the other hand can be used in preparing the client's hair to receive the hair coloring. Thus, the stability of the present base and bowl combination is important to the successful use of the present invention. Further, because at least some of the hair coloring preparations are in a paste form before mixing, the somewhat sticky paste could cause the bowl 14 to stick to a mixing implement and lift out of the base 14, or to turn with a mixing implement while remaining in the base 14. Both of these undesirable possibilities are addressed by the present invention, which provides for the bowl to be sufficiently non-rotational relative to the base and to be retained by the base 12.

While the present invention has been depicted and described by reference to a particularly preferred exemplary embodiment of the invention, such reference does not imply a limitation on the invention, and no such limitation is to be inferred. The invention is not limited to the particular preferred exemplary embodiment depicted and described, but is subject to modifications and alterations as will suggest themselves to those ordinarily skilled in the pertinent arts. The invention is intended to be limited by the spirit and scope of the appended claims, which provide a definition of the invention.

I claim:

1. In combination, a durable base and disposable bowl for allowing ingredients to be mixed in and dispensed from said bowl while the combination rests upon a support surface such as a countertop, said combination comprising:
a durable base member including a body defining an opening for receiving and substantially non-rotationally holding a disposable bowl member, and said base member further including facility for frictionally engaging said body upon a support surface;
a disposable bowl member formed of fine-dimension plastic material, and including a basin portion for being received into said opening and for receiving ingredients to be mixed in said disposable bowl portion, said disposable bowl member further including a radially outwardly extending flange portion circumscribing said basin portion and for being disposed adjacent to said body portion about said opening when said basin portion of said bowl member is placed into said opening; and
said body portion and said disposable bowl member defining cooperating means for substantially non-rotationally retaining said bowl member removably within said opening of said base member.

2. The combination of claim 1 wherein said cooperating means includes said opening of said base member being substantially but not completely circular, and said base member defining a radially inwardly and circumferentially extending integral key feature extending into said opening for non-rotational cooperation with said bowl member.

3. The combination of claim 2 wherein said cooperating means further includes said bowl member including a wall portion of fine-dimension plastic sheet material, and said wall portion integrally defining both said basin portion and said flange portion, and said basin portion further defining a radially inwardly and circumferentially extending divot for non-rotationally cooperating with and receiving said key feature of said base member when said bowl member is received into said opening.

4. The combination of claim 1 wherein said cooperating means includes said opening of said base member being substantially circular and of a determined diameter dimension, and said cooperating means further includes said bowl member including a wall portion of fine-dimension plastic sheet material, said wall portion integrally defining both said basin portion and said flange portion, and at said basin portion immediately adjacent to said flange portion said wall portion defining a circular diameter dimension which is a selected increment larger in outer diameter than said determined diameter, whereby said bowl member is a push-fit into said opening in order to seat said bowl portion in said opening with said flange portion adjacent to said body.

5. The combination of claim 1 wherein said cooperating means includes said opening of said base member being substantially circular and of a determined diameter dimension and of a certain vertical extent, and said body defining a larger dimension below said certain vertical extent;
said bowl member including a wall portion of fine-dimension plastic sheet material, said wall portion integrally defining both said basin portion and said flange portion, and at said basin portion immediately adjacent to said flange portion said wall portion defining a circumferential and vertical wall part of circular diameter dimension which is a selected increment larger in outer diameter than said determined diameter and of a size substantially matching said vertical extent, and below said wall part, said basin portion including a second wall part which is of greater diameter dimension still able to pass into said opening;
whereby said bowl member is a push-fit into said opening with said wall part snapping into engagement with said opening in order to seat said bowl portion in said opening with said flange portion adjacent to said body.

6. A combination durable base and disposable bowl for allowing ingredients to be mixed in and dispensed from the bowl while the combination rests upon a support surface such as a countertop, said combination comprising:
a durable base member including a weighty body defining an opening for receiving and substantially non-rotationally holding a disposable bowl member and for resting upon a support surface, said base including a top plate member defining said opening, and a pair of flange-like leg portions depending from said top plate member at opposite sides thereof to terminate in respective foot portions for resting upon said support surface, said flange-like leg portions each presenting a display surface upon which advertising may be carried;
a disposable bowl member formed of fine-dimension plastic material, and including a basin portion for being received into said opening and for receiving ingredients to be mixed in said disposable bowl portion, said disposable bowl member further including a radially outwardly extending flange portion circumscribing said basin portion and for being disposed adjacent to said body portion top plate portion about said opening when said basin portion of said bowl member is placed into said opening, and said basin portion centrally defining a flat portion for allowing said bowl itself to rest upright upon a support surface; and
said body portion at said opening further defining a radially inwardly and circumferentially extending key feature extending into said opening for non-rotational cooperation with said bowl member, and said basin portion of said bowl member defining a circumferentially and radially inwardly extending divot for non-rotationally cooperating with and receiving said key feature of said base member when said bowl member is received into said opening.

7. The combination of claim 6 wherein said bowl member is a light push-fit into said opening.

8. A integrally-formed plastic disposable bowl for mixing ingredients, said bowl comprising: a basin portion defining an opening to a basin in which ingredients may be deposited and mixed, and an integral circumferential flange portion circumscribing said opening, and both said basin portion and said flange portion being integrally formed of fine-dimension plastic sheet material, said basin portion centrally defining an outwardly disposed flat part for allowing said bowl to sit upright on a support surface, and said basin portion also outwardly defining a circumferential and radially inwardly extending divot for receiving an anti-rotation key feature, whereby said bowl is receivable into a base having an opening for receiving said basin portion and an anti-rotation key extending radially into said opening for cooperation with said divot.

9. A method of providing for mixing and dispensing of hair coloring preparations by a cosmetician, while positively preventing the passing of microbes between successive clients, said method comprising steps of:
providing a durable base including a body portion defining an opening for receiving and substantially non-rotationally holding a disposable bowl member;
providing on said base member a facility for frictionally engaging said body upon a support surface;
providing a disposable bowl member formed of fine-dimension plastic material, and configuring said disposable bowl member to include a basin portion for receipt into said opening of said durable base and for receiving ingredients to be mixed in said disposable bowl portion, configuring said disposable bowl member to include a radially outwardly extending flange portion circumscribing said basin portion and being disposed adjacent to said body portion about said opening when said basin portion of said bowl member is placed into said opening of said durable base member; and
configuring said body portion of said base and said disposable bowl member to define cooperating features for substantially non-rotationally retaining said bowl member removably within said opening of said base member.

10. The method of claim 9 further including steps of configuring said opening of said base member to be substantially but not completely circular, and providing on said base member a radially inwardly and circumferentially extending integral key feature extending into said opening for non-rotational cooperation with said bowl member.

11. The method of claim 10 further including steps of configuring said bowl member to include a wall portion of fine-dimension plastic sheet material integrally defining both said basin portion and said flange portion, and providing for said basin portion to define a radially inwardly and circumferentially extending divot for non-rotationally cooperating with and receiving said key feature of said base member when said bowl member is received into said opening.

12. The method of claim 9 further including steps of configuring said opening of said base member to be substantially circular and of a determined diameter dimension, and forming said wall portion of fine-dimension plastic sheet material of said bowl member to define a diameter dimension at said flange portion which is a selected increment larger in outer diameter than said determined diameter, whereby said bowl member is a light push-fit into said opening in order to seat said bowl portion in said opening with said flange portion adjacent to said body.

13. A method of mixing ingredients, said method comprising steps of:
providing a durable base member including a body portion defining an opening for receiving and substantially non-rotationally holding a disposable bowl member;
providing on said base member a facility for frictionally engaging said body upon a support surface;
providing a disposable bowl member configured to be received into said opening of said durable base member and including a basin portion for receipt into said opening of said durable base member and for receiving ingredients to be mixed in said disposable bowl portion,
configuring said body portion of said base and said disposable bowl member to define cooperating features for substantially non-rotationally retaining said bowl member removably within said opening of said base member, while said base member is frictionally supported upon said support surface so that ingredients may be mixed in said basin portion by a user utilizing only one hand without said base portion moving about on said support surface and without said bowl portion rotating relative to or removing from said base portion.
